(19) United States
(12) Patent Application Publication
(10) Pub. No.: US 2012/0310759 A1
(43) Pub. Date: Dec. 6, 2012

(54) COLLECTING AND REDEEMING DYNAMICALLY PRICED DEPOSITS ON GOODS

(76) Inventors: Steven Jeffrey Specht, Brookfield, CT (US); Alexander Boris Shelekhin, Ridgefield, CT (US)

(21) Appl. No.: 13/152,958

(22) Filed: Jun. 3, 2011

(51) Int. Cl. G06Q 30/06

(52) U.S. Cl. 705/26.1

(57) ABSTRACT

Goods may be collected and dynamically priced deposits may be redeemed to consumers. A good may be sold to a consumer and the details of the sale may be stored in a memory. A price may be collected for the good and this may be stored in the memory. A deposit on the good may be collected where the good may contain a unique code and where the deposit is correlated to a current market value of the good. The unique code may be stored with the details about the good in a memory where the unique code includes information representing at least one of whether the good is refurbish-able and whether the good contains desired recyclable material, a manufacturer of the good and a date of manufacture of the good. If the consumer consents, an indication of the consumer may be stored with the unique code. The returned good may be refurbished or recycled and the consumer may be offered a return of a deposit based on the current market value of the good which may be based on the value of the materials in the good.

### BACKGROUND

Goods are purchased and discarded at an ever increasing rate. Many of these good could be refurbished or may have materials that have value. However, due to the low cost of replacement goods and the difficulty in refurbishing or recycling goods, many goods end up in landfills even if the goods have possible value as the economic incentive to refurbish or recycle the good may be too small.

As an example, batteries provide portable power to many of today's modern devices. They can power devices for a reasonable period of time and are light enough in weight to be easily transportable. Batteries are usually made up of a variety of materials. In some examples, the batteries may be rechargeable and in other examples, the batteries may be disposable with materials that may be re-used. However, when a battery is discharged, they often are discarded without recovering the materials.

Rechargeable batteries have been developed. However, the voltage and capacity from rechargeable batteries may be less than comparable non-rechargeable batteries. In addition, rechargeable batteries may cost more initially and may require the additional purchase of a charger. Further, rechargeable batteries may have a maximum number of charges, e.g., cycle life, before the charge does not work effectively.

Non-rechargeable batteries may not be designed to be easily recharged, but the materials in such batteries may have value. However, separating and obtaining the materials from the battery is a challenge. For example, access to the materials inside an assembled battery may be difficult since the materials are inside a casing that is difficult to open so as to help reduce or prevent battery leakage. Further, convincing users to separate batteries from other refuse so that the material may be recovered also may be a difficulty. Often, the batteries end up in traditional trash containers and sorting through such trash may be an unpleasant task. Finally, the value of the materials may vary over time and some materials may be more desirable and than others.

### SUMMARY

According to one aspect of the claims, a method of collecting and redeeming dynamically priced deposits on goods 500 such as batteries is disclosed. The deposit 635 may provide an economic incentive for consumers to refurbish or recycle goods 500, especially if the economic incentive relates to the market for materials 615 in the goods 500. The method may be operated as a dedicated device 100, as a dedicated computer storage medium physically configured to store an application that physically transforms hardware or as a combination or hardware and software.

A good 500 may be sold to a consumer and details of the sale may be stored in a memory 134 or 150, such as a database 128 and/or in the memory 134 or 150. A price 620 may be collected for the good 500 and this may be stored in the memory 134 150. A deposit 635 on the good 500 may be collected where the good 500 may contain a unique code 510 and where the deposit 635 is correlated to a current market value 617 of the good 500. The unique code 510 may be stored with the good 500 in a memory 134 150 where the unique code 510 comprises information representing at least one of whether the good 500 is refurbish-able and whether the good 500 contains desired recyclable material 615, a manufacturer 540 of the good 500 and a date 530 of manufacture of the good 500. If the consumer consents, an indication of the consumer 670 may be stored with the unique code 510.

A returned good 500 may be collected from the consumer 670 to be refurbished and the unique code 510 of the returned good 500 may be reviewed to determine if the unique code 510 is recognized. If the returned good 500 is recognized, it may be determined if the good 500 is either refurbish-able or has recyclable material 615. If the good 500 is refurbish-able, it may be determined if the good 500 has been refurbished a number of times beyond a threshold. If it has not been refurbished beyond the threshold, the good 500 may be refurbished and prepared for sale. If the good 500 is recyclable, it may be determined if material 615 in the good 500 has been recycled previously. If the good 500 has not been recycled beyond a threshold, the materials 615 may be recycled.

It may be determined whether the consumer desires a replacement good 500. If the consumer does not desire a replacement good 500, a deposit 635 may be offered to be returned to the consumer 670 where the value of the deposit 635 correlates to the market price 617 of the materials 615 in the good 500. If the consumer 670 desires a replacement good 500, the consumer 670 may be offered a replacement good 500 where the price 620 of the good 500 correlates to the current market price 617 for the good and the unique code 510 of the replacement good 500 may be stored. If the consumer consents, an indication 625 of the consumer of the good 500 may be stored with the unique code 510.

### BRIEF DESCRIPTION OF THE DRAWINGS

FIG. 1 is an overview of a computing system that may be physically configured to execute computer instructions according to the claims;

FIG. 2 is an overview of a computing system that may be physically configured to execute computer instructions according to the claims;

FIG. 3 is an overview of a computing system that may be physically configured to execute computer instructions according to the claims;

FIG. 4 is an illustration of the logic flow of one embodiment of the claimed system;

FIG. 5 is an illustration of a good/battery with a unique code expanded;

FIG. 6 is an illustration of a memory with good/battery related information; and

FIG. 7 is an illustration of a device that implements the claimed system.

### SPECIFICATION

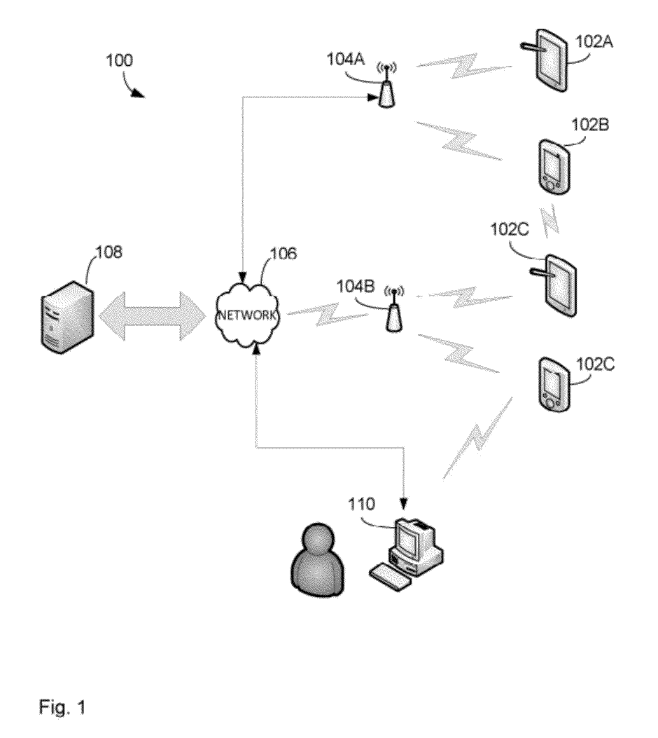

FIG. 1 depicts an embodiment of an exemplary system 100 for collecting and redeeming dynamically priced deposits on redeemable goods, such as batteries. Of course, the system is described as being applied to batteries, but the system could just as easily be applied to many devices that have materials that normally are thrown away but could be recycled to obtain the materials, especially if a deposit is included as part of the purchase price of the device where the deposit amount relates to the market value of the materials in the device. As an example and not limitation, consumer electronics are often discarded but have material which may be extracted and have value. Similarly, consumer product containers are often discarded but have materials which may be recycled or materials that may be extracted for value.

In some embodiments, the system 100 may include a plurality of mobile, multi-function computers 102, which may include mobile phones, smart phones, tablet computers, portable computers (e.g., laptop and netbook computers), personal digital assistants (PDAs), portable media players (PMPs), and the like. Throughout this specification, the term “mobile device” will be used to refer to any of these mobile, multi-function computers 102. The mobile devices 102 are generally characterized by: a general purpose microprocessor (i.e., one that can be programmed to perform different functions at different times, according to the desires of the user); a memory device and/or system, storing an operating system and a plurality of applications; a display; and an input mechanism, such as a keyboard, a touch screen, etc.

In the embodiment depicted in FIG. 1, the system 100 also includes a plurality of wireless routers or access points 104, which may allow the mobile devices 102 to communicate with others of the mobile devices 102, with a digital network 106, with a server 108, and/or with a workstation 110. As FIG. 1 illustrates, communication may, in various embodiments, occur directly between devices, through a local area network (LAN), or through a wide area network (WAN). For example, the mobile devices 102B and 102C are illustrated as communicating directly with each other, the mobile device 102D is illustrated as communicating directly with the workstation 110, and each of the mobile devices 102 is illustrated as communicating with the digital network 106 through the wireless router or access points 104, which may be communicatively connected to the digital network 106 via a wireless or wired connection. Throughout this specification, it is contemplated that in these various embodiments, communication may (but need not necessarily) occur between any and all of the mobile devices 102, the wireless access points 104, the digital network 106, the server 108, and/or the workstation 110.

The digital network 106 may be a proprietary network, a secure public Internet, a virtual private network or some other type of network, such as dedicated access lines, plain ordinary telephone lines, satellite links, combinations of these, etc. Where the digital network 106 comprises the Internet, data communication may take place over the digital network 106 via an Internet communication protocol.

As described in the following paragraphs, the system 100 may include an application executable on the mobile devices 102. The application, when executed by the mobile device 102, allows for collecting and redeeming dynamically priced deposits on redeemable batteries. In other embodiments, the application may operate on a remote server 108 and the display instructions may be served to the remote computing devices 102 over the network 106.

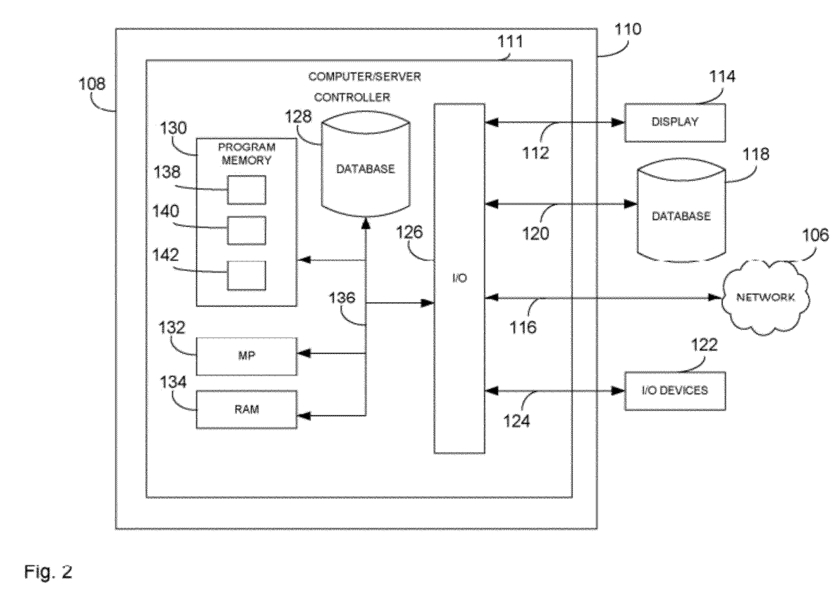

FIG. 2 depicts a block diagram of one possible embodiment of the server 108 or the workstation 110. The server 108 or the workstation 110 may have a controller 111 communicatively connected by a video link 112 to a display 114, by a network link 116 (i.e., an Ethernet or other network protocol) to the digital network 106, to a database 128 via a link 120, and to various other I/O devices 122 (e.g., keyboards, scanners, printers, etc.) by appropriate links 124. The links 112, 116, 120, and links 124 are each coupled to the server 108 via an input/output (I/O) circuit 126 on the controller 111. It should be noted that additional databases, such as a database 128 in the server 108 or other databases (not shown) may also be linked to the controller 111 in a known manner.

The controller 111 includes a program memory 130, a processor 132 (may be called a microcontroller or a microprocessor), a random-access memory (RAM) 134, and the input/output (I/O) circuit 126, all of which are interconnected via an address/data bus 136. It should be appreciated that although only one microprocessor 132 is shown, the controller 111 may include multiple microprocessors 132. Similarly, the memory of the controller 111 may include multiple RAMs 134 and multiple program memories 130. Although the I/O circuit 126 is shown as a single block, it should be appreciated that the I/O circuit 126 may include a number of different types of I/O circuits. The RAM(s) 134 and the program memories 130 may be implemented as semiconductor memories, magnetically readable memories, and/or optically readable memories, for example.

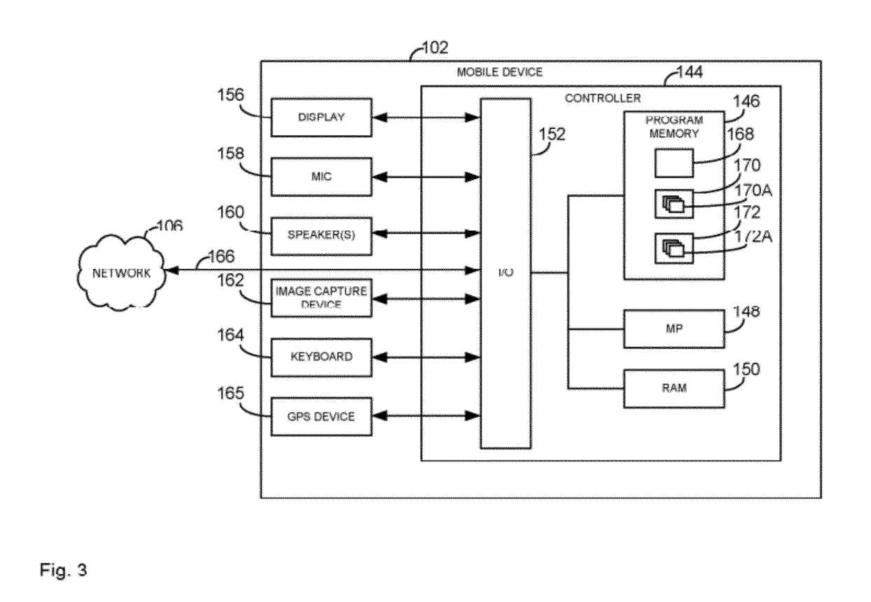

A block diagram of an exemplary embodiment of one of the mobile devices 102 is depicted in FIG. 3. Like the server 108 and workstation 110, the mobile device 102 includes a controller 144. The controller 144 includes a program memory 146, a processor 148 (may be called a microcontroller or a microprocessor), a random-access memory (RAM) 150, and an input/output (I/O) circuit 152, all of which are interconnected via an address/data bus 154. It should be appreciated that although only one microprocessor 148 is shown, the controller 144 may include multiple microprocessors 148. Similarly, the memory of the controller 144 may include multiple RAMs 150 and multiple program memories 146. Although the I/O circuit 152 is shown as a single block, it should be appreciated that the I/O circuit 152 may include a number of different types of I/O circuits. The RAM(s) 150 and the program memories 146 may be implemented as semiconductor memories, magnetically readable memories, and/or optically readable memories, for example.

The I/O circuit 152 may communicatively connect the other devices on the controller 144 to one or more other hardware devices in the mobile device 102. For example, the mobile device 102 includes an integrated display 156, which may be a touch sensitive display, a microphone 158, one or more speakers 160, an image capture device 162, a keyboard 164, and/or a geolocation device 165 (e.g., a global positioning system (GPS) receiver). If included, each of the microphone 158, the speakers 160, the image capture device 162, the keyboard 164, and the geolocation device 165 may be integrated in the mobile device 102 (e.g., in a mobile phone or a tablet computer), or may be a peripheral component. Additionally, the various components in the mobile device 102 may be integrated on a single printed circuit board (PCB) (not shown) and/or may be mounted within a single housing (not shown). Further, each of the other devices may operate individually such that the other devices may be turned on or off depending on the need to conserve battery life of the mobile device.

The I/O circuit 152 may also communicatively connect the controller 144 to the digital network 106, via a connection 166, which may be wireless (e.g., IEEE 802.11) or wireline (e.g., Ethernet) connections. In some embodiments, a chipset on or attached to the I/O circuit 152 may implement communication between the controller 144 and the digital network 106, while in other embodiments, an Ethernet device (not shown) and/or wireless network card (not shown) may comprise separate devices connected to the I/O circuit 152 via the address/data bus 154.

Either or both of the program memories 130 (FIG. 2) and 146 (FIG. 3) may contain machine-readable instructions (i.e., software) 138-142 (FIG. 2) and 168-172 (FIG. 3) for execution within the processors 132 (FIG. 2) and 148 (FIG. 3), respectively. The software 138-142 and 168-172 may perform the various tasks associated with operation of the server 108 and the mobile device 102, respectively, and may be a single module or a plurality of modules. While the software 138-142 and 168-172 is depicted in FIGS. 2 and 3 as including three modules each, the software 138-142 and 168-172 may include any number of modules accomplishing tasks related to operation of the system 100. For example, the software 138-142 depicted in FIG. 2 includes an operating system 138, server applications 140, and other program applications 142, each of which may be loaded into the RAM 134 and/or executed by the microprocessor 132. Similarly, the software 168-172 includes an operating system 168, one or more applications 170 and, specifically, an examination application 172. Each of the applications 170 may include one or more routines or modules 170A. Likewise, the examination application 172 may include one or more modules or routines 172A. In addition, the software may be stored on computer storage devices such as compact disks, dvds, flash memory devices, magnetic hard drives, other optical drives or other storage mediums.

In some embodiments, some portion or all of the I/O process 202 may be included at a client device, such as the client device 108 of FIG. 1. In some embodiments, some portion or all of the I/O process 202 may be included at a centrally available device or group of devices, such as a server, a group of networked computing devices, a peer-to-peer network, a cloud computing network, or other centrally available device or group of devices.

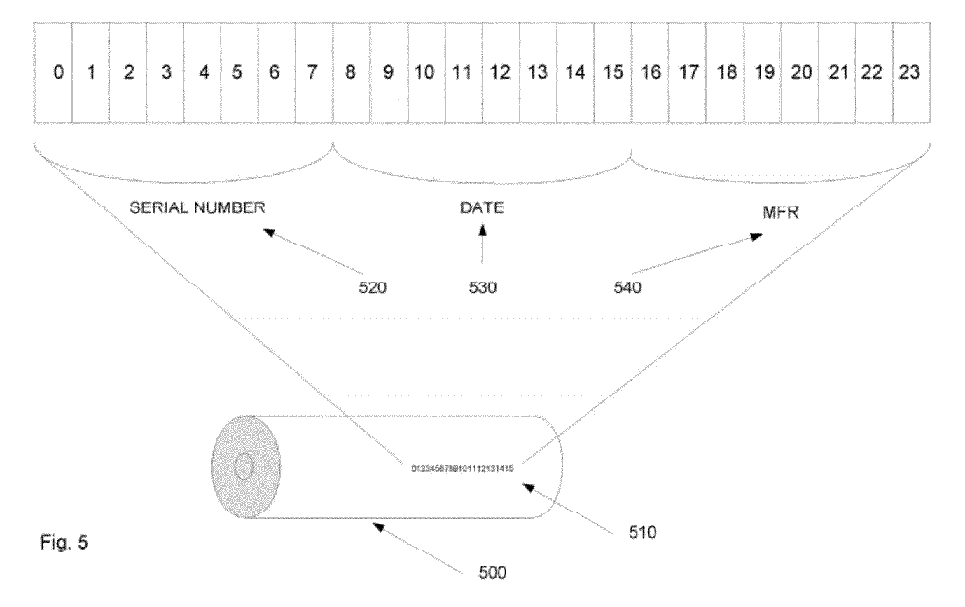

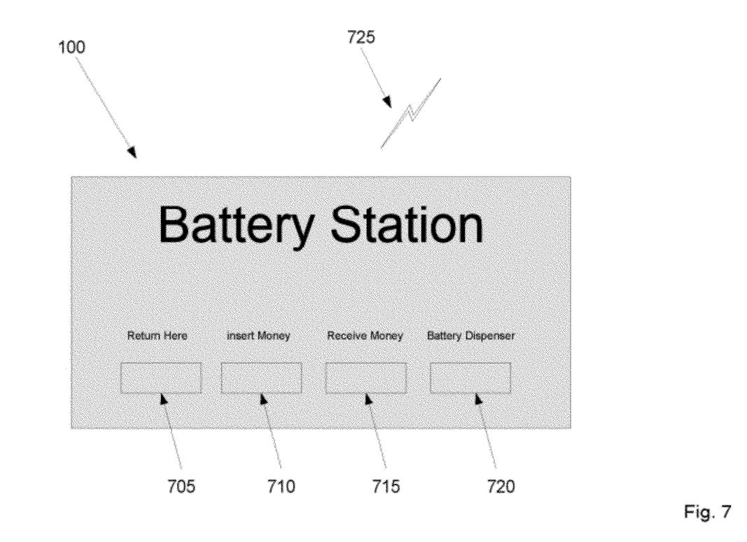

The computer system 100 may have many parts and the parts may be at separate locations as illustrated in FIG. 1. The processor may be physically configured according to computer executable instructions to redeem dynamically priced deposits on redeemable goods 500 (FIG. 5), such as batteries. In another embodiment, the system 100 is purpose built computing device 108 that is physically built for the sole purpose of collecting goods 500, like batteries, cell phones, smart phones, portable media players such as iPods®, batteries from cell phones, etc., and redeeming deposits on the goods 500. An example of such an embodiment is described further in FIG. 7.

As a general background, electrochemical cells, commonly referred to as a battery or batteries, such as battery depicted in FIG. 5, provide portable power to many of today's modern devices. The power from batteries can last for a reasonable period of time and batteries are of light enough in weight to be easily transportable. Batteries are usually made up of a variety of materials, some of which may be rare. The value of the materials may vary over time and some materials may be more desirable than others. However, when a battery is discharged, they often are discarded. Batteries may include an anode, a cathode, a separator therebetween, and an electrolyte, all of which are generally contained within some form of a housing. The anode, cathode, separator, and electrolyte are generally chosen for use within a particular battery design in accordance with various criteria, such as recharge-ability, voltage, and/or capacity.

Rechargeable batteries, also known as secondary batteries, contain active materials that are regenerated by charging. When the energy produced by these batteries is no longer capable to run a device, the batteries may be recharged in any one of many manners, depending upon their construction. Rechargeable batteries are broken down into classifications based upon the chemical composition of the battery, all which contain a wide assortment of battery styles. Examples of such classifications include rechargeable alkaline, lead-acid, nickel metal hydride, lithium ion, lithium ion polymer, lithium iron phosphate, lithium titanate, lithium cobaltate, and nickel cadmium. Rechargeable batteries have advantages and disadvantages. The voltage from rechargeable batteries may be less and the voltage may last for a shorter amount of time. In addition, rechargeable batteries may cost more initially and may require the additional purchase of a charger. Further, rechargeable batteries may have a maximum number of charges before the charge does not work effectively. However, over a long period of time, rechargeable batteries may be cheaper for a consumer depending on a variety of factors, such as use, cost of electricity, number of charges, etc.

Secondary electrochemical cells can be recharged many times, e.g., more than fifty times, more than a hundred times, or more. In some cases, secondary cells can include relatively robust separators, such as those having many layers and/or that are relatively thick. Secondary cells can also be designed to accommodate changes, such as swelling, that can occur in the cells. Secondary cells are described, e.g., in Falk & Salkind, “Alkaline Storage Batteries,” John Wiley & Sons, Inc. 1969; U.S. Pat. No. 345,124; and French Patent No. 164,681, all hereby incorporated by reference.

In contrast to secondary cells, primary electrochemical cells are meant to be discharged, e.g., to exhaustion, only once, and then discarded. Primary cells are not intended to be recharged. Primary cells are described, for example, in David Linden, Handbook of Batteries (McGraw-Hill, 2d ed. 1995). Examples of primary battery systems include zinc/manganese dioxide, magnesium/manganese dioxide, zinc/mercury oxide, zinc/silver oxide, zinc/air, lithium/manganese oxide, and lithium/iron disulfide. A computer system 100 may be used to assist in selling and collecting batteries and collecting and receiving deposits on the batteries.

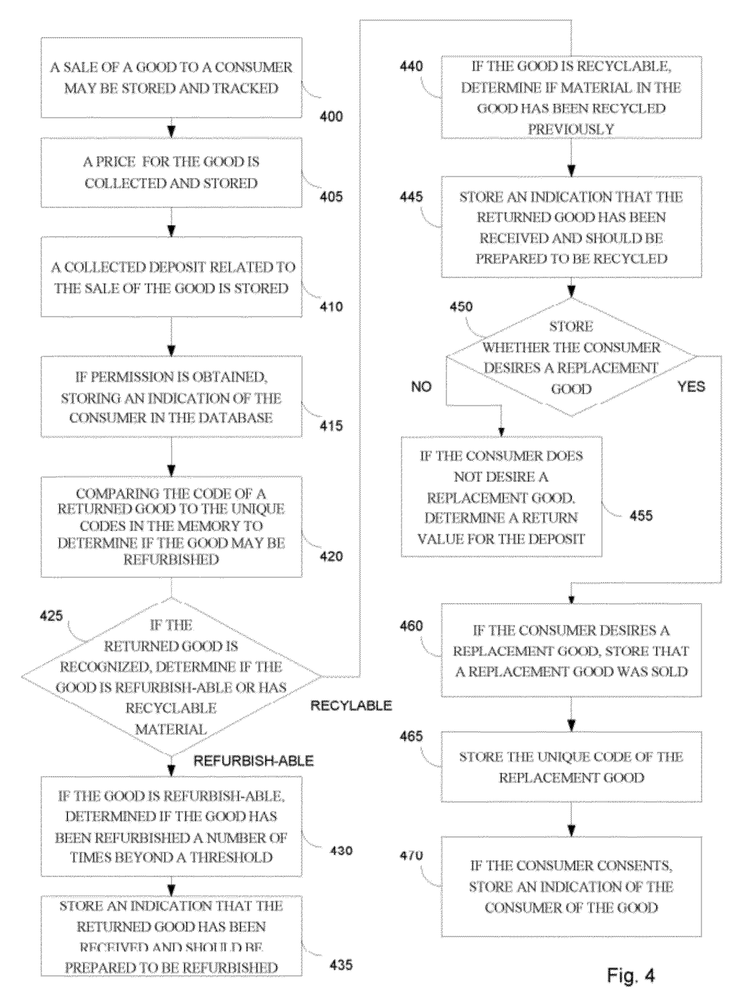

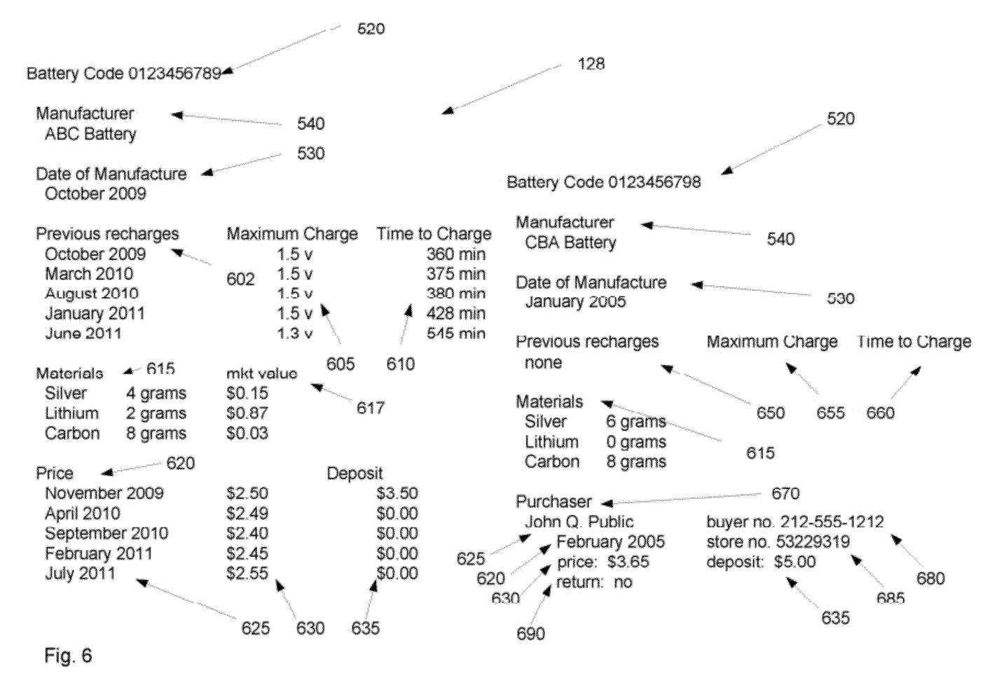

FIG. 4 may illustrate one embodiment of the many embodiments of a system 100 that assists in tracking and redeeming dynamically priced deposits on redeemable goods 500, such as a battery. Referring to FIG. 4, at block 400, a sale of the good 500 to a consumer 670 or other buyer may be stored in a memory such as memory 134 or 150 (FIG. 1). The memory 134 150 may or may not contain a database 128 such as the database depicted in FIG. 6. The database 128 may be virtually any type of database and the database 128 may be local such as in a portable device 102 or remote such as in server 108. In addition, the database 128 may be stored locally and communicated periodically to a remote storage mechanism. In yet another embodiment, the memory 134 150 may be stored in a “cloud” and may be reachable from a variety of separate computing devices. In yet another embodiment, raw data related to the sale may be stored locally and may be communicated periodically or as required to a central memory 134 150 at the central processor 108. Of course, other arrangements are possible and are contemplated.

The good 500 may contain a unique code 510. The unique code 510 may be a sequence of letters or digits which may provide a variety of information. In one example, the unique code 510 may be included as a traditional bar code. In another example, the unique code 510 may be an encrypted number that may be communicated to a central memory 134 150 where the number may be decrypted and added to the memory 134 150.

In some embodiments, the unique code 510 may be a radio frequency (RF) identification tag that is part of the good 500 packaging. In yet another embodiment, the unique code 510 may be a radio frequency (RF) tag that is part of the good 500 itself. In either embodiment, the RF tag is read by a RF reader, the RF data is stored in a memory and the RF data is communicated to a memory 134 150. In some embodiments, the RF data is sent as raw data where it is communicated and deciphered in a remote cloud and in another embodiment, the RF data is deciphered locally. Of course, other near field communication devices aside from RF identification tags also would be appropriate and are contemplated. Related, other embodiments are possible and are contemplated.

The memory 134 150 may contain as little information as the unique code 510 of the battery. In other embodiments, the memory 134 150 may also contain additional information as illustrated in FIG. 6. For example, the following data may be stored: The consumer 670 that purchased the good 500, the date of the sale 675, a buyer identification number (such as a store loyalty card, etc.) 680, the store where the good 500 was purchased 685, a price paid 630, and whether another good 500 was exchanged 690 for the new good 500, etc. The memory 134 150 also may contain other information about the good 500 such as when the good 500 was manufactured 530, who 540 manufactured the good 500, the materials 615 inside the good 500, whether the materials 615 have been reclaimed previously, the value 617 of the materials 615 in the good 500, whether the good 500 has been refurbished before 602 (i.e., if the good 500 is a battery, whether the battery has been recharged previously) and if so, how many times, how much the good 500 cost to produce, how much the good 500 was sold for 630, how the good 500 was used, etc. Of course, other data may be collected and stored in the memory 134 150 or database.

At block 405, a price 630 (FIG. 6) may be collected for the good 500 and stored in the memory 134 150. The price 630 may be set in a variety of ways. In some situations, the retailer has discretion to set the price 630. Logically, the price 630 may reflect the cost of the good 500 to the retailer plus a markup. In other embodiments, the good 500 manufacturer may subsidize the price 630 of the good 500 in order to make up more on future refurbishments. In other embodiments, the manufacturer may set a price floor which the price 630 may not fall below or may set a price ceiling of which the price 630 may not go above. Of course, other ways and manners of setting the price 630 are possible and are contemplated.

At block 410, a value of a deposit 635 (FIG. 6) that is collected related to the sale of the good 500 may be stored in a memory. The deposit 635 may be for several purposes. In one embodiment, if the good 500, such as a battery, is rechargeable, the deposit 635 may be used as an incentive for the consumer to return the good 500. In this situation, the manufacturer may be able to quickly refurbish the good 500, such as recharge the battery 500, and sell it again while the user does not have to pay the cost of the charger or the cost of the electricity to operate the charger. As another example, the good 500 may be a consumer electronic good that contains one or more commonly used logic processors. The logic processor may be removed and reused. Thus, the deposit 635 may represent a value of the used logic processor less the cost to remove the logic processor. As yet another example, some consumer goods 500 may have rechargeable batteries that are unchangeable without special tools and these devices may be suited for refurbishment or recycling.

If the good 500 is not rechargeable, the deposit 635 may represent the value 617 of the materials 615 in the good 500. The value 617 may be based on the current market value of the materials 615 in the good 500. The value 617 may also reflect a current cost to collect the goods 500 and to extract the materials 615 from the goods 500 and recondition the materials 615 for re-use. In one embodiment, the current cost may be pushed to the retail site from a central server 108. In another embodiment, the current cost may be pulled from a central server 108 whenever needed. In yet another embodiment, the current cost may be communicated periodically from a central server 108. In yet a further embodiment, the value of the deposit 635 may be an amount that has been determined to be sufficient to entice a desired number of consumers to return the good 500 and such a deposit 635 may or may not relate to the value of the materials 617 in the good 500.

In yet an additional embodiment, the value 617 of the materials 615 may be determined locally as some material prices 617 may vary by geographic location. For example, in a country where silver is plentiful and inexpensive, the value of extracting silver from a good 500 such as a battery may be small. At the same time, in a country where silver is rare and expensive, the value of extracting silver from a good 500 like a battery may be high. If the countries are geographically close, it may make sense to take goods 500 from one country and recycle them in another country or accept them in countries that are nearby countries where prices are high. Similarly, some manufacturers may have sources of silver that are expensive meaning there would be an increased economic incentive to recycle the silver from existing goods 500.

The deposit 635 may also represent a minimum value that may be returned to a user. For example, the consumer may purchase the goods 500 at a time when the prices of the materials in the good 500 are historically high. As such, the deposit 635 may be high at the time of purchase. Logically, a consumer 670 may expect to receive this same deposit 635 back at the time of returning the good 500 regardless of the current market price 617 of the materials 615 in the good 500. In addition, in some embodiments, the consumer 670 may receive a larger deposit 635 back if the price 617 of the materials 615 in the good 500 has increased further while in other embodiments, the consumer 670 may only receive the deposit 635 that was paid initially.

In some embodiments, the current market prices 617 and redeemable deposits 635 for different types of goods 500, such as batteries at different locations may be publically available. In some embodiments, the redeemable deposit 635 for the different types of goods 500 may be displayed at retail outlets. In other embodiments, the redeemable deposit 635 value at a given geographic location may be available online or through other appropriate research vehicles such as web sites. As an example, a consumer may be able to determine from the unique code 510 that a remote control car contains an TAS55 processor from Texas Instruments®. Assuming a deposit was paid on the remote control car, the deposit 635 may represent the value of a used TAS55 processor and this value may be advertised to the public.

At block 415, if the consumer 670 consents, an indication of the consumer 670 may be stored in the memory 134 150 along with the unique code 510 on the good 500. Permission may be needed as some consumers 670 may not desire to have their purchasing habits tracked in the memory 134 150. In other embodiments, consumers 670 may be part of a supermarket “club” where the consumer receives a better price on a good for showing a “club” card that tracks the purchasing habits of consumers 670 and this tracking number 680 may be stored in the memory, along with a store code 685.

At block 420 the code 510 of a returned good 500 may be compared to the unique codes 510 in the memory 134 150 or database 128 to determine if the unique code 510 is recognized as a good 500 that may be reconditioned. The code 510 may be from a returned good 500 that was not added to the memory 134 150. In such a case, the code 510 will not be recognized and the system 100 may not be able to refurbish the good 500 without additional review.

At block 425, if the returned good 500 is recognized, it may be determined if the good 500 is either refurbish-able or has recyclable material. In one embodiment, the unique code 510 on the good 500 may be compared to the codes 510 in the memory 134 150. If the code 510 matches, then the memory 134 150 can be queried to determine if the good 500 is indicated as being refurbish-able or recyclable. In some embodiments, the unique code 510 may not have an exact match or there may not be an indication whether the good 500 is refurbish-able or recyclable. In these situations, the code 510 may be further analyzed to determine if data about the good 500 may be interpreted to determine if the returned good 500 is refurbish-able or recyclable. As an example, the code 510 on the good 500 may contain several elements such as a serial number 520, a date of manufacture 530 and a manufacturer 540. The code 510 may indicate that it is from Manufacturer A 540. It may be known that all goods 500 from Manufacturer A 540 manufactured during 2007 (530) contain elements that may be recyclable. Thus, the system may classify the good 500 as a good 500 with elements that can be extracted and be recycled. In yet another embodiment, the lack of a complete match of the unique code 510 may indicate that the good 500 may be set aside for further analysis to determine if the good 500 is refurbish-able or recyclable. Of course, other embodiments are possible and are contemplated.

Refurbishing the good 500 may depend on the condition of the returned good 500. For example and not limitation, if the good 500 is a battery, the casing of the battery may be inspected and an indication may be stored on the condition of the casing. If the casing is damaged, an indication may be stored that the casing of the good (battery) 500 should be replaced. If the casing is not damaged, an indication may be stored that the casing is fine and the good 500 may continue on to be refurbished. Similarly, if the contacts on the good (battery) 500 are excessively worn, the contacts may have to be replaced before the good (battery) 500 may be re-sold.

The refurbishment may also include determining if the good 500 has desired recyclable materials 615 and storing an indication regarding the results of the determination. If the good 500 has desired recyclable materials 615, an indication may be stored that the desired recyclable materials 615 may be extracted from the good 500. If it is determined the good 500 does not have any desired recyclable materials 615, the good 500 may be provided to another good 500 handler.

At block 430, if the good 500 is refurbish-able, it may be determined if the good 500 has been refurbished 602 a number of times beyond a threshold. As an example and not limitation, the good 500 may be a rechargeable battery and the rechargeable battery may be capable of a limited number of recharges before the battery fails to accept a full charge or the battery discharges too quickly. Thus, a threshold may be used to determine if a rechargeable battery is no longer suitable for recharging 602 and reselling In some embodiments, the threshold may be a number of recharges 602. In other embodiments, the threshold may be based on the age of the good 500. In yet another embodiment, the threshold may be a combination of factors, including the age of the good 500 and the number of time the good 500 has been recharged.

In yet another embodiment, the good 500 may be studied over time and the threshold may relate to a prediction of success of refurbishing the good 500. For example, if the good 500 is a battery, the voltage that the battery has after being charged 605 may be tracked over time. If the maximum recharged voltage is under a threshold, the good (battery) 500 may be removed from circulation. Further, if the maximum charged voltage falls 605 over time and demonstrates a pattern that the good (battery) 500 is beginning to fail or act in an unacceptable manner, the good (battery) 500 may be pulled from circulation and evaluated further. In addition, the time 610 required to build up an acceptable voltage may also be evaluated, alone or over a period of time 610. If the good (battery) 500 is taking an extremely long time 610 to recharge, it may be an indication that the good (battery) 500 is close to failure and should be evaluated further. In addition, if the time 610 to recharge the good (battery) 500 grows over time, it may be an indication that failure is imminent and that the good (battery) 500 should be evaluated further. Of course, other manners of determining whether the good 500 may be falling under a threshold of acceptable performance may be possible and are contemplated with the threshold being appropriate for the type of good. As yet another example, if the good 500 is a logic processor, the processor logic may be checked for accuracy, power consumption, response time, etc.

At block 435, an indication may be stored that the returned good 500 has been received and should be prepared to be refurbished. If the good 500 is a battery, the refurbishment may be to recharge the good (battery) 500. However, if the good (battery) 500 has been recharged 602 an excessive number of times (or over a threshold number of times) or is not accepting a full charge (such as a minimum charge) or is taking an excessively long time to fully charge, the decision may be made to recycle the materials 615 in the good (battery) 500. Further, the condition of the casing of the good (battery) 500 may also affect the decision whether to recharge the battery or recycle the materials 615. In addition, good (battery) 500 formulations may improve and the materials 615 in the good (battery) 500 may be more effectively used by reformulating the materials 615 in the good (battery) 500. Of course, other factors may weigh on the decision regarding how to most effectively refurbish the good 500 depending on the type of good 500, the market conditions for materials 615, consumer demand, etc.

At block 440, if the good 500 is recyclable, it may be determined if material 615 in the good 500 has been recycled previously. The unique code 510 in the memory 134 150 or database for the good 500 may indicate that the material 615 in the good 500 may have been recycled previously. In addition, the unique code 510 may indicate information that may be interpreted to provide information about the materials 615 in the good 500 and whether the material 615 in the good 500 has likely been recycled previously. For example, the unique code 510 may indicate Manufacturer B 540 manufactured the good 500 in 2008 and the system may know that all goods 500 created by Manufacturer B in 2008 have levels of silver that can be recovered at a minimal cost.

If the material 615 has been recycled previously, depending on the material 615, it may be more difficult to recycle or not possible at all. In some cases, there may be a threshold number of time a material 615 may be recycled and it may be determined whether the threshold has been reached. The threshold may be based on time or age, number of times previously recycled 602, number of time recycles in a time period, etc.

At block 445, an indication may be stored that the returned good 500 has been received and should be prepared for refurbishment. In this case, the refurbishment may be to recycle the good 500 (as opposed to block 435 where the good 500 may be refurbished). Depending on the condition of the good 500, the decision may be made to recycle the materials 615 in the good 500. Further, the condition of the casing of the good may also affect the decision whether to refurbish the good 500 or recycle 615 the materials. In addition, good (battery) 500 formulations may improve and the materials 615 in the good 500 may be more effectively used by reformulating the materials 615 in the good 500. Of course, other factors may weigh on the decision regarding how to most effectively refurbish the good 500 depending on the type of good 500, etc.

At block 450, it may be noted in the memory 134 150 or database whether the consumer desires a replacement good 500. The consumer 670 may return a good 500 and may or may not desire a new good 500. The relevance of whether the consumer 670 desires a replacement good 500 has to do with whether to offer the consumer 670 a return of the deposit 635 or to keep the deposit 635 and offer the consumer 670 another good 500 without having to pay another deposit 635. If the consumer 670 has already made a deposit 635, then the user may be entitled to a return of the deposit 635 or have the previously paid deposit 635 applied to a new good 500.

At block 455, if the consumer 670 does not desire a replacement good 500, a return value for the deposit 635 may be determined and offered to the consumer 670. The value of the deposit 635 may correlate to the market price 617 of the materials 615 that make up the good 500 as mentioned in block 210. Also as mentioned, the market price 617 may depend on a variety of factors, such as the value of the materials 615 in the good 500, the need for the materials 615, the age of the materials 615, the likelihood that the materials 615 may be reconditioned, etc.

At block 460, if the consumer 670 desires a replacement good 500, the consumer 670 may be offered a replacement new good 500 for the price of the new good 500 where the price of the new good 500 correlates to the current market price for the good 500. The current market price of the good 500 may be determined in a variety of ways as mention in reference to block 205.

As an example and not limitation, a consumer 670 may have purchased a good (battery) 500 in November of 2009. The deposit 635 may have been $3.50 and the goods (batteries) 500 may have cost $2.50, meaning the good (batteries) 500 and the deposit cost $6.00. In April of 2010, the goods (batteries) 500 have been used in a radio controlled car and are discharged. The goods (batteries) 500 may be returned to a retailer 685. The retailer 685 may be able to determine that a deposit 635 was paid on the goods (batteries) 500 by looking up the unique code 510 on the goods (batteries) 500 in the memory 134 150 or database. The consumer 670 may be offered replacement goods (batteries) 500 at a market price and would not have to pay the deposit 635 again.

At block 465, the unique code 510 of the replacement good 500 may be stored. As mentioned previously, the unique code 510 may be virtually any code and may contain virtually any relevant information. Also, as mentioned previously, the code 510 may stored locally or remotely or may be stored locally and communicated to a remote server on demand or periodically.

At block 470, if the consumer 670 consents, an indication may be stored of the consumer 670 of the good 500 with the unique code 510. As mentioned previously, the consumer indication 670 may stored locally or remotely or may be stored locally and communicated to a remote server on demand or periodically.

FIG. 7 may illustrate one physical embodiment of a device 100 to implement the claimed system 100. The device 100 may accept goods 500 such as used batteries in an opening or slot 705. The device 100 may then size the goods (batteries) 500 and review the goods 500 for a unique code 510. The device may search local and remote 725 memories to determine if the good 500 is known based on the unique code 510. If the unique code 510 indicates a deposit 625 has been made, the consumer may be offered a return deposit 635 and the cash may offered through the receive money slot 715. In some embodiments, the deposit 635 may be based on what the consumer made as a deposit 625 and in other embodiments, the deposit 635 may be based on market values or conditions 617. The determination of the return deposit 635 may be made locally or by contacting 725, either through wired (Ethernet, token ring, web protocol, etc.) or wireless communications (wifi, cellular, etc.) devices in the device 100, remote servers. If the good 500 is not recognized, the device 100 may offer to return the good 500 to the user through slot 720 or may keep the good 500 for further analysis. The device 100 may have a container where returned goods 500 are stored for occasional pickup. The device 100 may be specific for the type of returned good 500, such as specifically for batteries or iPods®, cell phones, etc., or may be capable of accepting multiple types of goods 500.

If the good 500 is recognized, the system 100 may then determine if the good 500 is rechargeable and has not been refurbished beyond a threshold. The unique code 510 may be compared to the information in the memory 135 150 and it may provide sufficient knowledge of the good 500 to determine if it can be refurbished. In other embodiments, the good 500 may be tested by the device 100 to determine if it refurbish-able. If the good 500 is refurbish-able and has not been refurbished beyond a threshold, the device 100 itself may refurbish the good 500 for further sale. For example, if the good 500 is a rechargeable battery, the battery may be recharged in the device 100. In other embodiments, the good 500 is separated for refurbishing by an off-site vendor.

If the good 500 is not refurbish-able, the unique code 510 may give an indication whether the good 500 has materials 615 which may have value 617 if recycled. If there is value 617 in the materials 615 in the good 500, the device 100 may offer the user a return deposit 635 based the market value 617 of the materials 615. If there are no materials 615 of value 617 or the unique code 510 is not found or understood, the goods 500 may be offered to be returned to the user or the device 100 may offer to dispose of the goods 500 for the user.

The device 100 may also offer to sell the user new goods 500. If the user desires new or replacement goods 500, the goods 500 may be sold by the device 100. If a user already paid a deposit 635, the deposit 635 may be credited toward the sale. If the purchaser 670 has not paid a deposit 635, a deposit 635 may be required. The goods 500 may be provided through a slot in the device 100. The user may be stored in a memory 134 150 along with the unique code 510 of the goods 500 sold.

In some embodiments, the device 100 in FIG. 7 may be portable. In this way, the device 100 may be moved from location to location to pick up and sell goods 100 at locations that can be advertised to attract additional users and for ease of stocking the device 100 as a new device may be put in the place of a device 100 that needs servicing. In other embodiments, the device 100 is used in a single location and is serviced by an employee.

The device/system 100 may also be used beyond tracking data but for other proactive uses. As just one example, say a producer desires more of a material 615. The memory 134 150 may be queries to determine which consumers 670 have the desired material 615 and the consumers with the desired material 615 may be contacted with an offer to repurchase the material 615. As an another example, consumers 670 that have goods 500 older than a certain date may be contacted to offer them new goods 500 as their old goods 500 have likely outlived the useful life. Of course, the uses of the system are virtually limitless.

Describing all the possible embodiments of the system 100 would be impossible and alternate embodiments of the claimed system 100 are certainly possible and are contemplated. Further, elements of the various embodiments may be combined to create yet additional embodiments which are meant to be covered by the claims, the drawings and the specification.

What is claimed is:

1. A method of collecting and redeeming dynamically priced deposits on goods comprising:
Selling a good to a consumer comprising
collecting a price for the good;
collecting a deposit on the good wherein the good contains a unique code and wherein the deposit is correlated to a current market value of materials in the good;
storing the unique code with the good in a memory wherein the unique code comprises information representing at least one of:
whether the good is refurbish-able;
whether the good contains desired recyclable material;
a manufacturer of the good;
a date of manufacture of the good;
if the consumer consents, storing an indication of the consumer with the unique code;
collecting a returned good from the consumer to be refurbished or recycled comprising;
receiving the returned good;
reviewing the unique code of the returned good to determine if the unique code is recognized;
if the returned good is recognized,
determining if the good is either refurbish-able or has the desired recyclable material;
if the good is refurbish-able, determining if the good has been refurbished a number of times beyond a threshold;
if the good is recyclable, determining if material in the good has been recycled previously;
determining whether the consumer desires a replacement good;
if the consumer does not desire the replacement good,
offering to return the deposit to the consumer wherein a value of the deposit amount correlates to a market price of the materials in the good or the deposit initially made by the consumer;
if the consumer desires the replacement good,
offering the consumer a replacement good for the price of the good wherein the price of the good correlates to a current market price for the good;
storing the unique code of the replacement good;
if the consumer consents, storing an indication of the consumer of the good with the unique code; and
preparing the returned good to be refurbished.

2. The method of claim 1, wherein refurbishing the good comprises:
inspecting the good,
if the good is damaged beyond repair, arranging for the good to be properly disposed of;
if the good is damaged but is reparable, arranging for the good to be repaired;

3. The method of claim 1, wherein refurbishing the good further comprises:
determining if the good has desired recyclable materials;
if the good has the desired recyclable materials, extracting the desired recyclable materials from the good; and
if the good does not have the desired recyclable materials, providing the good to another good handler.

4. The method of claim 1, wherein refurbishing the good further comprises if the good is a rechargeable good,
recharging the good;
repackaging the good; and
preparing the good for sale.

5. The method of claim 1, wherein a market value of the good further comprises a determined sum of value of materials in the good reduced by a cost to remove and recondition the desired materials to be recycled.

6. The method of claim 1, wherein a system for performing the method is housed in a single device that may be moved from a first location to a second location.

7. The method of claim 1, wherein the deposit is a minimum value that is returned to a user.

8. The method of claim 6, further comprising making a current market price publically available.

9. The method of claim 1, further comprising if a producer desires more of a desired resource,
determining which consumers have the good with the desired resource,
contacting the consumers with the desired resource, and
offering to repurchase the desired resource.

10. The method of claim 1, wherein the unique code is at least one selected from a group comprising:
a radio frequency identification signal;
an encrypted sequence; and
a bar code.

11. The method of claim 1, wherein the good is a battery.

12. A computer system comprising a processor physically configured according to computer executable instructions, a memory physically configured to store the computer executable instructions and an input/output circuit, the computer executable instructions comprising instructions for collecting and redeeming dynamically priced deposits on batteries comprising instructions for:
Storing data regarding selling a battery to a consumer comprising
collecting a price amount for the battery;
collecting a deposit amount on the battery wherein the battery contains a unique code and wherein the deposit amount is correlated to a current market value of the battery;
storing the unique code with the battery in a memory wherein the unique code comprises information representing at least one of:
whether the battery is rechargeable;
whether the battery contains desired recyclable material;
a manufacturer of the battery;
a date of manufacture of the battery;
if the consumer consents, storing an indication of the consumer with the unique code;
collecting data to be analyzed related to a returned battery from the consumer to be recharged or recycled comprising;
reviewing codes on the returned battery to determine if the code is one of the unique codes;
if the returned battery has one of the unique codes,
determining if the battery is either rechargeable or has the desired recyclable material;
if the battery is rechargeable, determining if the battery has been recharged a number of times beyond a threshold;
if the battery is recyclable, determining if material in the battery has been recycled previously;
if the consumer does not desire a replacement battery,
offering to return the deposit amount to the consumer wherein a value of the deposit amount correlates to a market price of the materials in the battery or the deposit initially made by the consumer;
if the consumer desires the replacement battery,
offering the consumer a replacement charged battery for a price of the battery wherein the price of the battery correlates to a current market price for the battery;
storing the unique code of the replacement charged battery;
if the consumer consents, storing an indication of a consumer of charged battery with the unique code; and
storing that the returned battery is to be refurbished.

13. The computer system of claim 12, wherein the computer executable instruction for refurbishing the battery further comprises computer executable instructions for:
inspecting a casing of the battery;
if the casing is damaged, replacing the casing of the battery;
if the casing is not damaged, proceeding to refurbish the battery.

14. The computer system of claim 12, wherein the computer executable instructions for refurbishing the battery further comprise computer executable instructions for:
determining if the battery has desired recyclable materials;
if the battery has the desired recyclable materials, indicating that the desired recyclable materials should be extracted from the battery; and
if the battery does not have the desired recyclable materials, indicating that the battery should be provided to another battery handler.

15. The computer system of claim 12, wherein the computer executable instructions for refurbishing the battery further comprises if the battery is a rechargeable battery, computer executable instructions for:
determining the method appropriate for recharging the battery;
determining a desired manner to repackage the battery; and
arranging for the battery to be sold.

16. The computer system of claim 12, wherein the computer executable instruction for determining a market value of the battery further comprises computer executable instructions for determining a sum of value of materials in the battery as indicated by the unique code on the battery.

17. The computer system of claim 16, wherein the computer executable instructions reduce the market value of the battery by a determined cost to remove and recondition the desired resources based on the unique code on the battery.

18. The computer system of claim 12, wherein the computer executable instructions determine market value by contacting a centralized network for current market prices.

19. The computer system of claim 12, wherein the computer executable instructions further comprise if a producer desires more of a resource,
determining which consumers have desired resource,
contacting the consumers with the desired resource, and
offering to repurchase the resource.

20. The computer system of claim 12, wherein the unique code is at least one selected from a group comprising:
a radio frequency identification signal;
an encrypted sequence; and
a bar code.
